(19) United States
(12) Patent Application Publication
(10) Pub. No.: US 2013/0266345 A1
(43) Pub. Date: Oct. 10, 2013

(54) POWDER CONVEYANCE DEVICE AND IMAGE FORMING APPARATUS INCLUDING SAME

(71) Applicants: Junichi MATSUMOTO, Kanagawa (JP); Atsushi KUROKAWA, Kanagawa (JP); Kentaro MIKUNIYA, Tokyo (JP)

(72) Inventors: Junichi MATSUMOTO, Kanagawa (JP); Atsushi KUROKAWA, Kanagawa (JP); Kentaro MIKUNIYA, Tokyo (JP)

(21) Appl. No.: 13/850,623

(22) Filed: Mar. 26, 2013

(30) Foreign Application Priority Data
Apr. 9, 2012 (JP) 2012-088203

(51) Int. Cl. G03G 15/08

(52) U.S. Cl. CPC G03G 15/0832
USPC 399/258

(57) ABSTRACT

A powder conveyance device including a reciprocating displacement pump, through which powder, together with air, passes to be conveyed from an origin to a destination using negative pressure and positive pressure alternately generated in the reciprocating displacement pump by changing an internal volume of the reciprocating displacement pump, and a drive part connected to the reciprocating displacement pump to drive the reciprocating displacement pump. A period of time to increase the internal volume of the reciprocating displacement pump to generate the negative pressure is set longer than a period of time to reduce the internal volume of the reciprocating displacement pump to generate the positive pressure.

### CROSS-REFERENCE TO RELATED APPLICATION

This patent application is based on and claims priority pursuant to 35 U.S.C. §119 to Japanese Patent Application No. 2012-088203, filed on Apr. 9, 2012, in the Japan Patent Office, the entire disclosure of which is hereby incorporated by reference herein.

### BACKGROUND

1. Technical Field

The present invention generally relates to a powder conveyance device that conveys powder such as developer, and an image forming apparatus including the powder conveyance device.

2. Related Art

Related-art image forming apparatuses, such as copiers, printers, facsimile machines, and multifunction devices having two or more of copying, printing, and facsimile capabilities, typically form a toner image on a recording medium (e.g., a sheet of paper, etc.) according to image data using, for example, an electrophotographic method. In the electrophotographic method, for example, a charger charges a surface of an image carrier (e.g., a photoconductor); an irradiating device emits a light beam onto the charged surface of the photoconductor to form an electrostatic latent image on the photoconductor according to the image data; a developing device develops the electrostatic latent image with a developer (e.g., toner) to form a toner image on the photoconductor; a transfer device transfers the toner image formed on the photoconductor onto a sheet of recording media; and a fixing device applies heat and pressure to the sheet bearing the toner image to fix the toner image onto the sheet. The sheet bearing the fixed toner image is then discharged from the image forming apparatus.

The image forming apparatuses often include a power conveyance device using a displacement pump that conveys powder such as developer composed of toner or a mixture of toner and carrier. Examples of reciprocating displacement pumps, which take in liquid, air, or powder from outside and then discharge it from the pumps using pressure generated therein by repeatedly changing the volume of internal space of the pumps (hereinafter referred to as internal volume), include, but are not limited to, a diaphragm pump, a piston pump, and a bellows pump.

Thus, the powder conveyance device may employ a diaphragm pump in which a crankshaft positioned eccentric from a drive shaft of a motor is inserted into an insertion hole formed in a movable part of a diaphragm. The motor is driven to rotate the crankshaft in a circular path so that an internal volume of the pump is repeatedly changed. As a result, toner collected to a collection case by cleaning devices or a belt cleaning device is conveyed, together with air, by the diaphragm pump to a hopper connected above a developing device, which is disposed away from the collection case.

In another approach, the powder conveyance device uses a diaphragm pump in which a circular eccentric cam is positioned eccentric from a drive shaft of a motor. The eccentric cam is rotated in a circular path by the motor to vertically move a ring having a hole, that is, a cam follower, so that an internal volume of the pump is repeatedly changed via a diaphragm drive member. As a result, toner conveyed to a mixing chamber from a toner container via a first hopper is mixed with air in the mixing chamber and then is conveyed, together with air, by the diaphragm pump to a separation chamber connected via a second hopper above the developing device, which is disposed apart from the toner container. In the separation chamber, the toner is separated from the air.

However, use of a reciprocating displacement pump in the powder conveyance device to convey fine powder such as toner entails the following problems. That is, in the configuration in which the toner or the like is conveyed within a tube such as a hose using the reciprocating displacement pump, a pressure change within the pump generated by the change in the internal volume of the pump generates an airflow that disperses the toner in air or fluidizes it to be conveyed to the destination. However, although air is the medium by which the toner is conveyed, it may cause various problems once the toner reaches its destination.

Although the speed of toner conveyed to the destination together with air varies depending on an amount of flow of toner and air for unit time (hereinafter also referred to as amount of flow per unit time), the toner flows into the destination, together with air, at a certain speed. Consequently, toner originally stored in the destination in advance is stirred and scattered by the toner and air flowing into the destination. Such toner may spill outside the destination via a small gap or the like at the destination. Further, in a case in which the destination is sealed, the pressure within the destination is increased as the toner flows into the destination together with air, thereby damaging a housing or possibly causing toner leakage from seals.

To prevent damage and toner leakage, a vent filter is often provided to suppress the increase in the internal pressure of the destination. However, the vent filter is easily clogged with toner and thus frequent replacement is required. In addition, because the vent filter is not so porous in order to block the toner, it is difficult to suppress the increase in the internal pressure of the destination immediately and thus difficult to convey a larger amount of air to the destination.

To solve the above problems, in the first example powder conveyance device described above, provision of the vent filter, which is generally provided to an upper portion of the destination, that is, the hopper, is omitted. Instead, an upper space of the hopper and an air intake opening of the collection case are connected by a hose to prevent the increase in the internal pressure of the hopper.

With regard to the second example powder conveyance device described above, air is taken from the destination, that is, the separation chamber, using another diaphragm pump to return the air to an upper space of the mixing chamber connected to the separation chamber via a tube, thereby preventing the internal pressure of the separation chamber from increasing.

However, the farther the distance to convey the toner, the larger the amount of air used for conveyance of the toner, thus increasing the internal volume of the diaphragm pump, which is repeatedly changed for conveying the toner together with air, or the amount of flow of toner and air per unit time conveyed by the diaphragm pump. In general, the amount of flow of toner and air per unit time is increased by increasing rotary speed of the motor that drives the diaphragm pump and rotating the motor at a constant speed. In other words, during operation of the diaphragm pump, a period of time to increase the internal volume of the diaphragm pump to generate a negative pressure within the diaphragm pump is set identical to a period of time to reduce the internal volume of the diaphragm pump to generate a positive pressure within the diaphragm pump. As a result, although the amount of flow of toner and air per unit time taken into the internal space of the diaphragm from the toner container is increased, the amount of flow of toner and air per unit time discharged from the internal space of the diaphragm to the destination is also increased similarly.

The increase in the amount of flow of toner and air per unit time discharged from the diaphragm pump also increases the speed of toner and air flowing into the destination. Consequently, toner originally stored in the destination in advance is stirred and scattered, and such toner may spill outside the destination via a small gap or the like. Further, an amount of toner scattered and then adhering to the interior of the hose or the tube that connects the destination such as the hopper or the separation chamber to the air intake opening or the mixing chamber accumulates within the hose or the tube, blocking the flow of air and thereby degrading conveyance performance of the diaphragm pump.

### SUMMARY

In view of the foregoing, illustrative embodiments of the present invention provide a novel powder conveyance device using a reciprocating displacement pump that reduces scattering of fine powder at a destination and a novel image forming apparatus including the powder conveyance device.

In one illustrative embodiment, a powder conveyance device includes a reciprocating displacement pump, through which powder, together with air, passes to be conveyed from an origin to a destination using negative pressure and positive pressure alternately generated in the reciprocating displacement pump by changing an internal volume of the reciprocating displacement pump, and a drive part connected to the reciprocating displacement pump to drive the reciprocating displacement pump. A period of time to increase the internal volume of the reciprocating displacement pump to generate the negative pressure therein is set longer than a period of time to reduce the internal volume of the reciprocating displacement pump to generate the positive pressure therein.

In another illustrative embodiment, an image forming apparatus includes a developing device to develop an image with developer including toner or a mixture of toner and carrier, a container disposed separately from the developing device to store the developer, and the powder conveyance device described above.

Additional features and advantages of the present disclosure will become more fully apparent from the following detailed description of illustrative embodiments, the accompanying drawings, and the associated claims.

### BRIEF DESCRIPTION OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a vertical cross-sectional view illustrating an example of configuration of an image forming apparatus according to illustrative embodiments;

FIG. 2 is a schematic view illustrating an example of a configuration of a developing device and a toner supply device according to a first illustrative embodiment;

FIG. 3 is a schematic view illustrating an example of a configuration of a drive part that drives the toner supply device;

FIG. 4(a) is a vertical cross-sectional view of an eccentric shaft provided to a related-art diaphragm pump viewed from a direction perpendicular to an axial direction of the eccentric shaft;

FIG. 4(b) is a graph showing movement of the eccentric shaft illustrated in FIG. 4(a) over time;

FIG. 5(a) is a vertical cross-sectional view of an eccentric shaft according to the first illustrative embodiment viewed from a direction perpendicular to an axial direction of the eccentric shaft;

FIG. 5(b) is a graph showing movement of the eccentric shaft illustrated in FIG. 5(a) over time;

FIG. 6 is a vertical cross-sectional view illustrating a configuration of a diaphragm pump and a sub-hopper used for an experiment;

FIG. 7 is a graph showing a comparison of a cumulative collected amount of airborne toner in a related-art diaphragm pump to that of the diaphragm pump according to the first illustrative embodiment based on the experiment; and

FIG. 8 is a vertical cross-sectional view illustrating an example of a configuration of a bellows pump included in a toner supply device according to a second illustrative embodiment.

### DETAILED DESCRIPTION

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that has substantially the same function, operate in a similar manner, and achieve a similar result.

Illustrative embodiments of the present invention are now described below with reference to the accompanying drawings. In a later-described comparative example, illustrative embodiment, and exemplary variation, for the sake of simplicity the same reference numerals will be given to identical constituent elements such as parts and materials having the same functions, and redundant descriptions thereof omitted unless otherwise required.

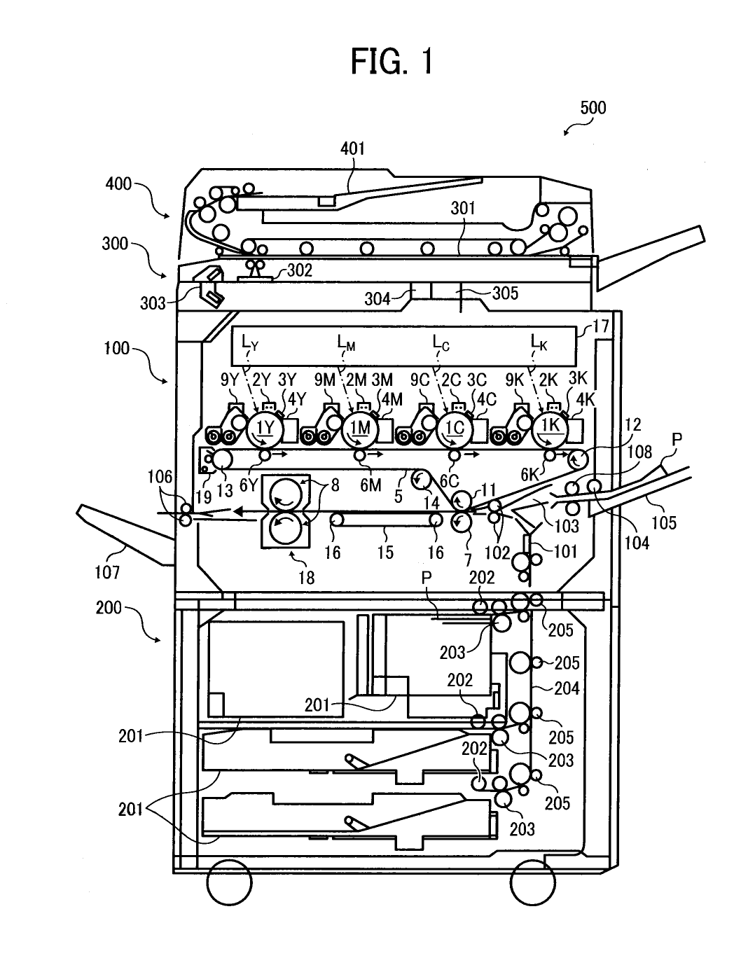

A description is now given of an example of a configuration of an image forming apparatus 500 according to illustrative embodiments. FIG. 1 is a vertical cross-sectional view illustrating an example of a configuration of the image forming apparatus 500.

It is to be noted that the image forming apparatus 500 is a tandem-type full-color multifunction device employing an electrophotographic method and uses two-component developer including toner and carrier. The image forming apparatus 500 includes a body 100, a sheet feed table 200 on which the body 100 is placed, a scanner 300 attached above the body 100, and an automatic document feeder (ADF) 400 attached to an upper part of the scanner 300. The image forming apparatus 500 forms images on a recording medium such as a sheet of paper (hereinafter referred to as sheet P) based on image data read by the scanner 300 or print data sent from an external device such as a personal computer. The body 100 of the image forming apparatus 500 includes latent image carriers, which in the present illustrative embodiment, are photoconductors 1Y, 1M, 1C, and 1K (hereinafter collectively referred to as photoconductors 1) each forming a toner image of a specific color, that is, yellow (Y), magenta (M), cyan (C), or black (K). The photoconductors 1 are arranged side by side along a direction of rotation of an endless intermediate transfer belt 5 wound around multiple rollers including a drive roller to contact the intermediate transfer belt 5.

Electrophotographic processing members such as chargers 2Y, 2M, 2C, and 2K (hereinafter collectively referred to as chargers 2), developing devices 9Y, 9M, 9C, and 9K (hereinafter collectively referred to as developing devices 9), cleaning devices 4Y, 4M, 4C, and 4K (hereinafter collectively referred to as cleaning devices 4), and neutralizing lamps 3Y, 3M, 3C, and 3K (hereinafter collectively referred to as neutralizing lamps 3) are provided around the photoconductors 1, respectively, in the order in which they come into play as processing proceeds. An optical writing device 17 is disposed above the photoconductors 1. Primary transfer devices, which, in the present illustrative embodiment, are primary transfer rollers 6Y, 6M, 6C, and 6K (hereinafter collectively referred to as primary transfer rollers 6), are disposed opposite the respective photoconductors 1 with the intermediate transfer belt 5 interposed therebetween.

The intermediate transfer belt 5 is wound around support rollers 11, 12, and 13 and a tension roller 14 and is rotated as the drive roller, that is, the support roller 12, is rotatively driven by a drive source, not shown. A belt cleaning device 19 is provided opposite the support roller 13 with the intermediate transfer belt 5 interposed therebetween to remove residual toner from the intermediate transfer belt 5 after secondary transfer of a toner image from the intermediate transfer belt 5 onto the sheet P, which is described in detail later. The support roller 11 functions also as a secondary transfer opposing roller provided opposite a secondary transfer device, which, in the present illustrative embodiment, is a secondary transfer roller 7. A secondary transfer nip is formed between the support roller 11 and the secondary transfer roller 7 via the intermediate transfer belt 5.

A conveyance belt 15 wound around a pair of support rollers 16 is provided downstream from the secondary transfer nip in a direction of conveyance of the sheet P to convey the sheet P having the secondarily transferred toner image thereon to a fixing device 18. The fixing device 18 includes a pair of fixing rollers 8 constructed of a heat roller and a pressing roller. Heat and pressure are applied to the sheet P at a fixing nip between the heat roller and the pressing roller to fix the toner image onto the sheet P.

A description is now given of image formation performed by the image forming apparatus 500. During full-color image formation, first, a document is set on a document stand 401 included in the ADF 400. Alternatively, the ADF 400 is opened to set a document on a contact glass 301 of the scanner 300, and thereafter, the ADF 400 is closed. In a case in which the document is set on the document stand 401, the document is conveyed onto the contact glass 301 when a start button, not shown, is pressed. At the same time, the scanner 300 is driven to scan the document with first and second scanning members 302 and 303. Light emitted from the first scanning member 302 is reflected from the document placed on the contact glass 301, and the light thus reflected is further reflected from a mirror included in the second scanning member 303 to be guided to a reading sensor 305 via an imaging lens 304. Thus, image data of the document is read.

In addition, upon pressing of the start button, a motor, not shown, is driven to rotatively drive the drive roller, that is, the support roller 12, so that the intermediate transfer belt 5 is rotated in a clockwise direction in FIG. 1. At the same time, the photoconductors 1 are rotated in a counterclockwise direction in FIG. 1 by a photoconductor drive device, not shown, and are evenly charged by the chargers 2, respectively. Then, light beams L_{Y}, L_{M}, L_{C}, and L_{K} are directed from the optical writing device 17 onto the photoconductors 1, respectively, so that electrostatic latent images of the specified colors are formed on the photoconductors 1, respectively. The electrostatic latent images thus formed on the photoconductors 1 are developed by the developing devices 9 with toner of developer to form toner images of the specified colors on the photoconductors 1, respectively. During the development, a predetermined developing bias is applied between each photoconductor 1 and a developing roller included in each developing device 9. Accordingly, toner borne on the developing roller is electrostatically attracted to the electrostatic latent image formed on each photoconductor 1.

The toner images thus formed on the photoconductors 1 are conveyed, as the photoconductors 1 rotate, to primary transfer positions where the photoconductors 1 contact the intermediate transfer belt 5, respectively. A predetermined transfer bias is applied to a back surface of the intermediate transfer belt 5 by the primary transfer rollers 6 at the primary transfer positions. Accordingly, the toner images are primarily transferred from the photoconductors 1 onto the intermediate transfer belt 5, respectively, by primary transfer electric fields generated by the application of the transfer bias. As a result, the toner images are sequentially transferred onto the intermediate transfer belt 5 one atop the other to form a single full-color toner image on the intermediate transfer belt 5. The belt cleaning device 19 removes residual untransferred toner from the intermediate transfer belt 5 after the secondary transfer of the toner image described in detail later.

Further, upon pressing of the start button, one of sheet rollers 202 included in the sheet feed table 200 is rotated based on a selected type of sheet P so that sheets P are fed from a corresponding sheet feed cassette 201. The sheets P thus fed are separated one by one by a separation roller 203 so that each sheet P enters a sheet feed path 204 and is further conveyed by a conveyance roller 205 to a sheet feed path 101 in the body 100 of the image forming apparatus 500. Thereafter, conveyance of the sheet P is temporarily stopped at a pair of registration rollers 102. In a case of manual sheet feeding, a sheet feed roller 104 feeds sheets P set on a manual sheet tray 105, and a separation roller 108 separates the sheets P one by one to convey each sheet P to the pair of registration rollers 102 via a manual sheet feed path 103. Thereafter, conveyance of the sheet P is temporarily stopped at the pair of registration rollers 102.

Meanwhile, the full-color toner image formed on the intermediate transfer belt 5 is conveyed to the secondary transfer position opposite the secondary transfer roller 7 as the intermediate transfer belt 5 rotates. Rotation of the pair of registration rollers 102 is started in synchronization with the toner image formed on the intermediate transfer belt 5 to convey the sheet P to the secondary transfer position. A predetermined bias is applied to a back surface of the sheet P by the secondary transfer roller 7 at the secondary transfer position so that the full-color toner image is secondarily transferred from the intermediate transfer belt 5 onto the sheet P by a secondary transfer electric field generated by the application of the predetermined bias and pressure at the secondary transfer position. Thereafter, the sheet P having the full-color toner image thereon is conveyed to the fixing device 18 by the conveyance belt 15 to fix the toner image onto the sheet P using the pair of fixing rollers 8. The sheet P having the fixed image thereon is then discharged from the image forming apparatus 500 by a pair of discharge rollers 106 and is stacked on a discharge tray 107.

A description is now given of a powder conveyance device using a reciprocating displacement pump, which, in the illustrative embodiments, is a toner supply device 70. It is to be noted that all of the multiple toner supply devices 70 for each one of the specified toner colors that supply the toner to the respective developing devices 9 have the same basic configuration, differing only in the color of toner used. Therefore, suffixes Y, M, C, and K, each representing the color of toner, are hereinafter omitted.

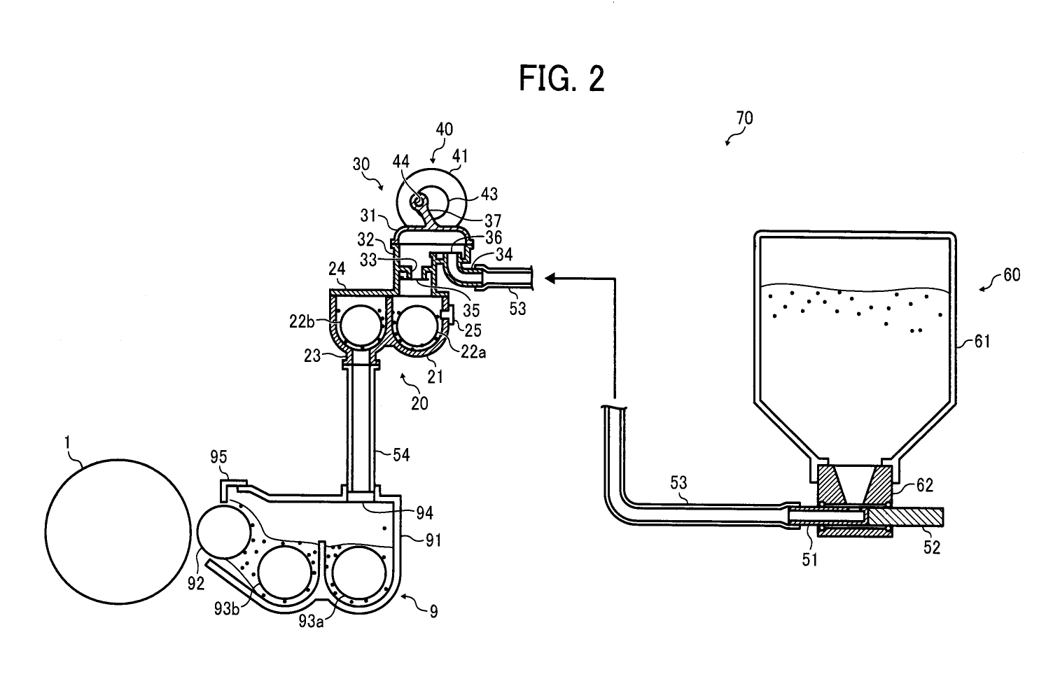

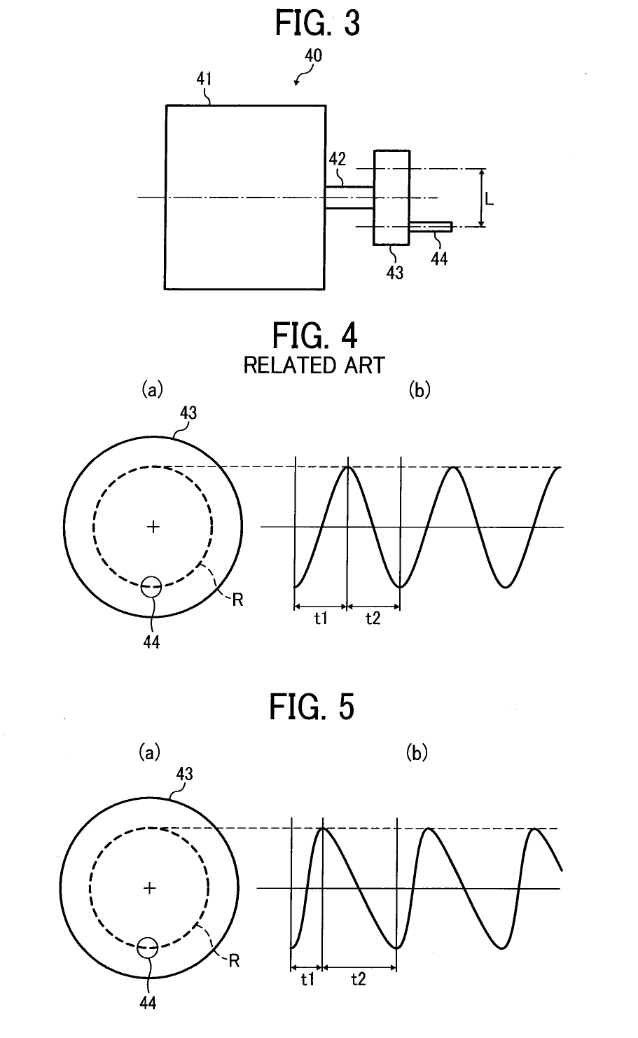

A configuration of the toner supply device 70 according to a first illustrative embodiment is described in detail below, with reference to FIGS. 2 and 3. FIG. 2 is a schematic view illustrating an example of a configuration of the developing device 9 and the toner supply device 70 according to the first illustrative embodiment. FIG. 3 is a schematic view illustrating an example of a configuration of a drive part 40 that drives the toner supply device 70.

The toner supply device 70 according to the first illustrative embodiment includes a sub-hopper 20, in which fine powder, that is, toner to be supplied to the developing device 9, is temporarily stored, and a supply route, which, in the present illustrative embodiment, is a toner duct 54 that communicates the sub-hopper 20 and the developing device 9 to convey the toner. The toner supply device 70 further includes a reciprocating displacement pump, which, in the present illustrative embodiment, is a diaphragm pump 30 provided above the sub-hopper 20, and a tube 53 that communicates the diaphragm pump 30 with a toner container 60 detachably installable in the body 100 of the image forming apparatus 500. The toner sucked from the toner container 60, together with air, by the diaphragm pump 30 is conveyed through the tube 53.

The diaphragm pump 30 takes in the toner, together with air, from an origin, that is, the toner container 60, via the tube 53 and then discharges the toner to a destination, that is, the sub-hopper 20 connected below the diaphragm pump 30, so that the toner is conveyed from the toner container 60 to the sub-hopper 20. The toner thus conveyed to the sub-hopper 20 is supplied to the developing device 9 by a conveyance member provided within the sub-hopper 20.

The developing device 9, to which the toner is supplied from the toner container 60 by the toner supply device 70, employs the two-component developing system using developer composed of toner and carrier and includes a developing roller 92 that bears and conveys the developer to a developing range opposite the photoconductor 1. The developer is stored within a housing 91 of the developing device 9. The housing 91 includes an agitation/conveyance part, within which a first screw 93a is disposed, and a supply/collection part, within which a second screw 93b is disposed. The developer is supplied to the developing roller 92 from the supply/collection part, and the developer, which is not supplied to the developing roller 92, is returned and collected to the supply/collection part. Communication parts are provided to both ends of the agitation/conveyance part and the supply/collection part in the axial direction of the first and second screws 93a and 93b, respectively, so that the developer stored within the housing 91 is circulated between the agitation/conveyance part and the supply/collection part by the first and second screws 93a and 93b. As described above, the developer which is not supplied from the supply/collection part to the developing roller 92 is collected and returned to the supply/collection part.

The developing roller 92 bears the developer agitated within the supply/collection part thereon using a magnetic force to convey the developer to the developing range, so that toner of the developer is supplied to the electrostatic latent image formed on the photoconductor 1 at the developing range to form a toner image on the photoconductor 1. A doctor blade 95 that restricts a thickness of the developer borne on the developing roller 92 is provided to an opening formed in an upper corner of the housing 91, from which the developing roller 92 is exposed.

The sub-hopper 20, within which the toner supplied from the toner container 60 is temporarily stored, is disposed above the agitation/conveyance part of the developing device 9, so that the toner discharged from the sub-hopper 20 falls by gravity through the toner duct 54 to be supplied to the agitation/conveyance part of the developing device 9. The developing device 9 further includes a toner density sensor, not shown. When the toner density sensor detects toner consumption within the developing device 9, an amount of toner corresponding to an amount of toner consumed is supplied from the sub-hopper 20 to the developing device 9 based on the result detected by the toner density sensor, so that a predetermined toner density is kept in the developing device 9.

The sub-hopper 20 has two tanks arranged side by side within the sub-hopper 20. Specifically, an upstream tank, to which the toner discharged together with air from the diaphragm pump 30 is conveyed, and a downstream tank connected to the toner duct 54 are provided within a hopper housing 21 of the sub-hopper 20. Upstream and downstream screws 22a and 22b are provided within the upstream and downstream tanks, respectively. Based on the toner density detected by the toner density sensor provided to the developing device 9, a predetermined amount of toner is discharged, by rotation of the screws 22a and 22b, from a toner discharge opening 23 provided to the downstream tank of the sub-hopper 20 and is supplied to the developing device 9 via the toner duct 54 connected to the toner discharge opening 23.

A toner end sensor 25 that detects an amount of toner within the upstream tank of the sub-hopper 20 is provided to a lateral wall of the hopper housing 21 within which the upstream tank is provided. When consumption of the toner within the sub-hopper 20 is detected by the toner end sensor 25, the diaphragm pump 30 connected above the upstream tank of the sub-hopper 20 is driven to supply toner from the toner container 60 to the sub-hopper 20.

The toner container 60, from which the toner is supplied to the developing device 9 by the toner supply device 70, is constructed of a toner storage 61 and a base 62, and detachably installable in the body 100 of the image forming apparatus 500. The base 62 has a cylindrical shutter 52 movable in the horizontal direction in FIG. 2. A nozzle 51 is inserted into an end of the tube 53 on the toner container 60 side and fixed at the end of the tube 53. In a state in which the nozzle 51 does not communicate with the base 62, that is, setting of the toner container 60 in the body 100 of the image forming apparatus 500 is not completed yet, the shutter 52 is constantly biased leftward in FIG. 2 by a spring or the like, not shown. Accordingly, before installation of the toner container 60 in the body 100 of the image forming apparatus 500, or upon detachment of the toner container 60 from the body 100, toner leakage from the toner container 60 is prevented.

When the nozzle 51 is inserted into the base 62 of the toner container 60, the shutter 52 is pressed and moved to communicate the interior of the toner storage 61 with the tube 53, into which the nozzle 51 is inserted. In other words, an inlet 34 provided to a pump housing 32 of the diaphragm pump 30, which is connected to the opposite end of the tube 53, communicates with the interior of the toner storage 61 of the toner container 60 via the tube 53. Thereafter, the diaphragm pump 30 is driven to convey the toner from the toner storage 61 of the toner container 60 to the sub-hopper 20. Examples of materials used for the tube 53 include, but are not limited to, toner-resistant rubber such as polyurethane, nitrile, and ethylene-propylene-diene monomer (EPDM).

A configuration and operation of the diaphragm pump 30 according to the present illustrative embodiment are described in greater detail below. The diaphragm pump 30 is constructed of the pump housing 32, a diaphragm 31, an intake valve 36, and a discharge valve 35. A transmission member 37 that converts and transmits rotation of an eccentric shaft 44 rotated by a drive motor 41 provided to a drive part 40 into vertical movement of a movable part of the diaphragm 31 is provided above the diaphragm 31. One end of the transmission member 37 is connected to the substantial center of the movable part of the diaphragm 31, and the opposite end of the transmission member 37 has a hole into which the eccentric shaft 44 rotated in a circular path by the drive motor 41 is fitted. The transmission member 37 converts the rotation of the eccentric shaft 44 into vertical deformation of the movable part of the diaphragm 31 to change a volume of an internal space formed by the pump housing 32 and the diaphragm 31 (hereinafter also referred to as an internal volume of the diaphragm pump 30).

The inlet 34 is a curved L-shaped tube provided to the pump housing 32, and through the inlet 34, the toner and air are taken into the internal space formed by the pump housing 32 and the diaphragm 31. The intake valve 36, one end of which is supported, is provided closably openable to an end of an opening of the inlet 34 protruding toward the internal space. An outlet 33 of the pump housing 32 is a linear tube, and the toner and air are discharged outside the internal space from the outlet 33. The discharge valve 35, one end of which is supported, is provided closably openable to an end of an opening of the outlet 33 protruding outward.

As illustrated in FIGS. 2 and 3, in the drive part 40, a holding member 43 having a short cylinder in an axial direction thereof is fixed to a leading end of a drive shaft 42 of the drive motor 41. The eccentric shaft 44 is rotatably held parallel to the center of the drive shaft 42 by the holding member 43 via a bearing, not shown, at a position offset by a predetermined amount from the center of the drive shaft 42 in a diametrical direction of the holding member 43. When the drive motor 41 is rotatively driven, the eccentric shaft 44 is moved vertically in a stroke L shown in FIG. 3 while being rotated. Upstroke and downstroke of the eccentric shaft 44 by the amount of stroke L deforms the movable part of the diaphragm 31 so that the internal volume of the diaphragm pump 30 is repeatedly changed to alternately generate negative and positive pressure therein.

In order to facilitate an understanding of the present illustrative embodiment, reference is now made to an example of a conventional configuration and common problems thereof. FIG. 4(a) is a vertical cross-sectional view of an eccentric shaft provided to a related-art diaphragm pump viewed from a direction perpendicular to the axial direction of the eccentric shaft. FIG. 4(b) is a graph showing movement of the eccentric shaft illustrated in FIG. 4(a) over time. It is to be noted that the same reference numerals as those of the present illustrative embodiment are also used in FIG. 4(a) for ease of comparison, and horizontal and vertical axes in FIG. 4(b) represent a period of time elapsed and upstroke and downstroke of the eccentric shaft that deform the diaphragm, respectively.

In the related-art diaphragm pump, the center of the eccentric shaft 44 is moved, while being rotated, along a track R indicated by broken-line circle in FIG. 4(a). In a case in which the related-art diaphragm pump is driven to have a predetermined conveyance property, the drive motor 41 is rotated at a predetermined constant speed corresponding to the predetermined conveyance property. The upstroke and downstroke of the eccentric shaft 44 in such a case as the time elapses is represented as a sine wave as shown in FIG. 4(b).

Because the drive motor 41 is rotated at the predetermined constant speed corresponding to the predetermined conveyance property as described above, the upstroke of the eccentric shaft 44 pulls the diaphragm 31 upward so that the internal volume is increased and thus a pressure within the internal space is reduced. At this time, the discharge valve 35 is closed and the intake valve 36 is opened, so that the toner is taken, together with air, into the internal space of the pump housing 32 from the toner container 60. By contrast, the downstroke of the eccentric shaft 44 pushes the diaphragm 31 downward so that the internal volume is reduced and thus the pressure within the internal space is increased. At this time, the discharge valve 35 is opened and the intake valve 36 is closed, so that the toner is discharged, together with air, from the outlet 33 of the diaphragm pump 30.

The above-described processes are repeated to convey the toner from the toner container 60 to the sub-hopper 20. During a time t1 in FIG. 4(b), the diaphragm 31 is deformed upward to increase the internal volume of the diaphragm pump 30, thereby generating negative pressure. During a time t2 in FIG. 4(b), the diaphragm 31 is deformed downward to reduce the internal volume of the diaphragm pump 30, thereby generating positive pressure. In other words, during intake of the toner, that is, the time t1, the negative pressure is generated within the internal space. By contrast, during discharge of the toner, that is, the time t2, the positive pressure is generated within the internal space. In the related-art reciprocating displacement pump such as the diaphragm pump, the time t1 and the time t2 are set identical to each other. This means that an amount of flow of toner and air for unit of time (hereinafter referred to as an amount of flow per unit time) during the intake and the discharge is the same.

FIG. 5(a) is a vertical cross-sectional view of the eccentric shaft 44 according to the first illustrative embodiment viewed from a direction perpendicular to the axial direction of the eccentric shaft 44. FIG. 5(b) is a graph showing movement of the eccentric shaft 44 over time according to the first illustrative embodiment. Similar to FIG. 4(b), horizontal and vertical axes represent a period of time elapsed and upstroke and downstroke of the eccentric shaft 44, respectively, in FIG. 5(b). In the diaphragm pump 30 according to the present illustrative embodiment, similar to the related-art configuration illustrated in FIG. 4(a), the center of the eccentric shaft 44 is moved, while being rotated, along a track R indicated by broken-line circle in FIG. 5(a). However, as shown in FIG. 5(b), in the present illustrative embodiment, the diaphragm pump 30 is driven such that the time t1 during the intake of the toner is shorter than the time t2 during the discharge of the toner (t1<t2). Accordingly, although the internal volume of the diaphragm pump 30 is changed by the same amount for both the intake and discharge of the toner, the diaphragm pump 30 is driven in a shorter period of time during the intake compared to the discharge so that the amount of flow per unit time during the intake is increased while the amount of flow per unit time during the discharge is reduced.

The reduction in the amount of flow per unit time during the discharge of toner reduces the amount of toner and air supplied from the diaphragm pump 30 to the sub-hopper 20 using the positive pressure generated within the internal space compared to the related-art diaphragm pump in which the same time is set for both increasing and reducing the internal volume of the diaphragm pump. Accordingly, a speed of toner and air flowing into the sub-hopper 20 is reduced, thereby suppressing scattering of the toner originally stored in the sub-hopper 20 compared to the related-art configuration. Thus, the toner supply device 70 according to the present illustrative embodiment suppresses toner scattering within the sub-hopper 20 using the diaphragm pump 30.

In general, the sub-hopper 20 and the toner container 60 are positioned away from each other as illustrated in FIG. 2. The longer the distance between the sub-hopper 20 and the toner container 60 and the lower the position of the toner container 60 relative to the diaphragm pump 30, the larger the amount of air and the higher the pressure used for the intake of the toner into the diaphragm pump 30. In such a case, in general, an amount of change in the internal volume of the diaphragm pump 30 is increased, or rotary speed of the drive motor 41 that drives the diaphragm pump 30 is increased, to increase the amount of flow per unit time.

In the method in which the toner is conveyed using an airflow, deterioration in flowability of toner caused by environmental change or the like often hinders smooth conveyance of the toner. In addition, in consideration of deterioration in performance of the diaphragm pump 30 over time, it is conceivable to increase the amount of flow per unit time as much as possible and thus reduce the variation in the amount of conveyance of toner caused by the deterioration in flowability. However, in the related-art diaphragm pump in which the time t1 for the intake of toner is the same as the time t2 for the discharge of toner, the amount of flow per unit time during the discharge is also increased similarly to the increase in the amount of flow per unit time during the intake. Consequently, the increase in the amount of flow per unit time during the discharge of the toner increases the speed of toner and air discharged from the diaphragm pump 30, causing toner scattering within the sub-hopper 20.

Further, not only the toner scattering but also the problem described below may occur. The toner end sensor 25 detects a top layer of toner temporarily stored in the sub-hopper 20 to control the amount of toner within the sub-hopper 20. However, the increase in the amount of flow of toner and air per time discharged from the diaphragm pump 30 also increases the speed of toner and air flowing into the sub-hopper 20 as described above. Consequently, the toner and air flowing into the sub-hopper 20 stirs the toner originally stored within the sub-hopper 20 and disturbs the top layer of the toner, thereby hindering precise detection of the amount of toner stored within the sub-hopper 20 using the toner end sensor 25.

In the toner supply device 70 according to the present illustrative embodiment, the amount of flow per unit time during the intake of toner into the diaphragm pump 30 from the toner container 60 is increased while the amount of flow per unit time during the discharge of toner from the diaphragm pump 30 is decreased, thereby preventing the above-described problems.

Thus, in the configuration of the present illustrative embodiment in which the toner is taken into the diaphragm pump 30 from the toner container 60 disposed away from the diaphragm pump 30, the amount of flow per unit time during the intake of toner is increased while the amount of flow per unit time during the discharge of toner from the diaphragm pump 30 is decreased. As a result, the problems caused by toner scattering within the sub-hopper 20, which is the destination of the toner discharged from the diaphragm pump 30, are prevented. In particular, in the configuration in which the distance between the diaphragm pump 30 and the destination of toner, that is, the sub-hopper 20, is relatively short as in the case of the present illustrative embodiment, relatively little air is used to discharge the toner from the diaphragm pump 30 to the sub-hopper 20. Therefore, further reduction in the amount of flow per unit time during the discharge of toner can be achieved, thereby more reliably reducing toner scattering within the sub-hopper 20.

In other words, because the sub-hopper 20 and the diaphragm pump 30 are disposed close to each other in the configuration of the present illustrative embodiment, the toner can be discharged, together with air, from the diaphragm pump 30 to the sub-hopper 20 with the pressure and the amount of flow per unit time considerably smaller than those used for the intake of toner into the diaphragm pump 30. As a result, the time to reduce the internal volume of the diaphragm pump 30 to generate the positive pressure therein can be set further longer than the time to increase the internal volume of the diaphragm pump 30 to generate the negative pressure therein, thereby considerably reducing toner scattering within the sub-hopper 20.

Application of the present illustrative embodiment to powder conveyance devices that convey developer including toner or toner and carrier suppresses toner scattering within the destination of the toner. As a result, toner spilling within the body 100 of the image forming apparatus 500 caused by the toner scattering can be prevented, and thus preventing various problems caused by the toner spilling.

A description is now given of an experiment performed by the inventors to confirm the effects of the present illustrative embodiment.

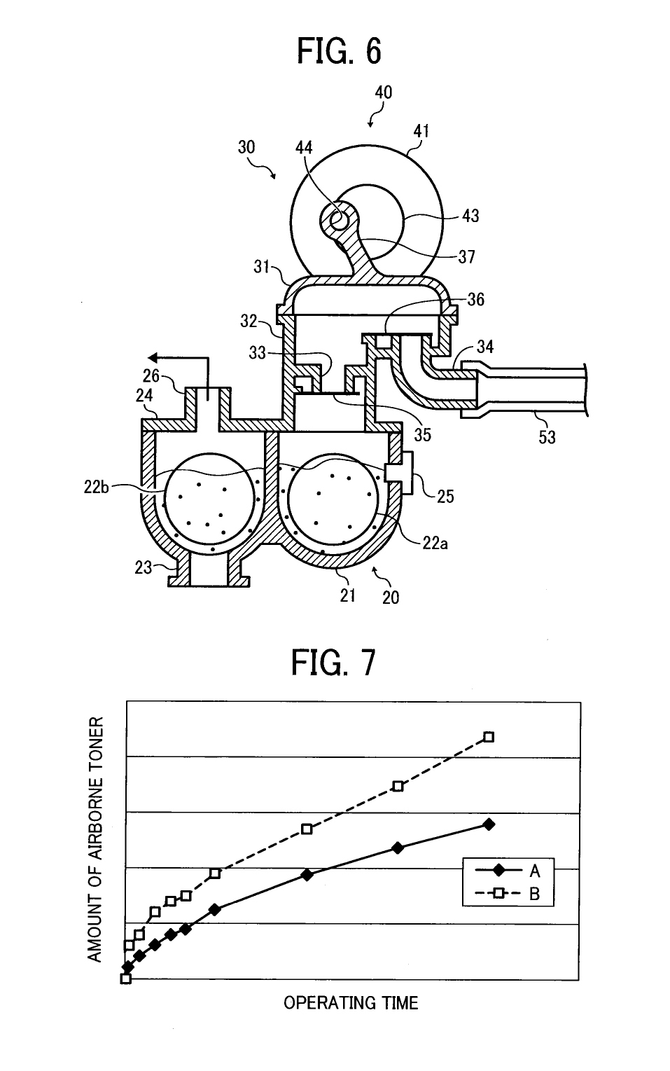

FIG. 6 is a vertical cross-sectional view illustrating the diaphragm pump 30 and the sub-hopper 20 of a toner supply device used for the experiment. In the toner supply device illustrated in FIG. 6, a communication part 26 having an opening that communicates with the exterior of the sub-hopper 20 is provided to an upper housing 24 of the downstream tank of the sub-hopper 20, within which the downstream screw 22b is disposed. During the experiment, the diaphragm pump 30 was driven at predetermined intervals to convey toner. The upstream and downstream screws 22a and 22b of the sub-hopper 20 were rotated by driving of the diaphragm pump 30 to supply the toner to the developing device 9.

When the diaphragm pump 30 was driven, internal pressure in the upstream and downstream tanks of the sub-hopper 20 was increased, respectively, so that a part of the toner scattered within the sub-hopper 20 was discharged outside from the opening of the communication part 26 as airborne toner. A cumulative amount of airborne toner thus discharged from the opening of the communication part 26 was measured. The cumulative amount of airborne toner in the related-art configuration, in which the time t1 during the intake of toner and the time t2 during the discharge of toner are set identical to each other, was compared to a cumulative amount of airborne toner in the configuration of the present illustrative embodiment, in which the time t1 and the time t2 are set to have a ratio of 1 to 1.5. It is to be noted that a sum of the time t1 and the time t2, that is, a total time for a single reciprocal stroke of the diaphragm pump 30, was identical in both the related-art configuration and the diaphragm pump 30 according to the present illustrative embodiment. In addition, the related-art configuration and the diaphragm pump 30 according to the present illustrative embodiment used for the experiment had the same basic configuration, differing only in the ratio of the time t1 to the time t2.

FIG. 7 is a graph showing the results of the experiment. The solid line A in FIG. 7 represents the results for the diaphragm pump 30 according to the present illustrative embodiment, and the broken line B in FIG. 7 represents the results for the related-art configuration.

As shown in FIG. 7, the cumulative amount of airborne toner was smaller in the diaphragm pump 30 according to the present illustrative embodiment than the related-art configuration. Thus, it was confirmed that the diaphragm pump 30 according to the present illustrative embodiment more securely suppresses toner scattering compared to the related-art configuration.

It is to be noted that in the configuration in which the diaphragm 31 is vertically moved by the drive motor 41 and the eccentric shaft 44, control of the rotary speed of the drive motor 41 during a single reciprocal stroke of the diaphragm pump 30 is repeated periodically to easily vary the time t1 and the time t2 from each other. Alternatively, a cam member having an asymmetric shape relative to a rotary shaft or a quick-return motion mechanism may be used to vary the period of time for the upstroke of the diaphragm 31 from the period of time for the downstroke of the diaphragm 31.

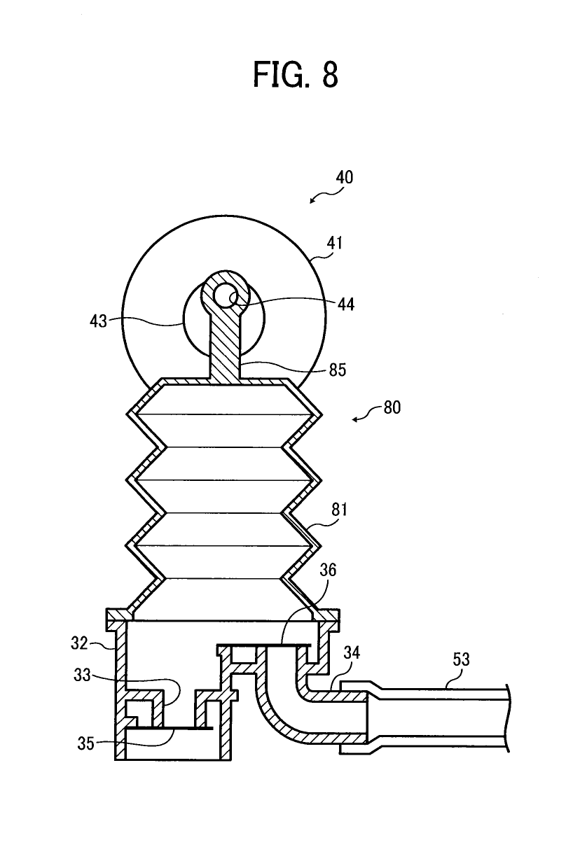

A description is now given of a second illustrative embodiment of the present invention. FIG. 8 is a vertical cross-sectional view illustrating an example of a configuration of a bellows pump 80 included in the toner supply device 70 according to the second illustrative embodiment. The only difference between the first and second illustrative embodiments is the type of reciprocating displacement pump used in the toner supply device 70. Therefore, the same reference numerals for those components substantially the same as the first illustrative embodiment are used also in the second illustrative embodiment.

In place of the diaphragm pump 30, the bellows pump 80 is used in the toner supply device 70 according to the second illustrative embodiment. The difference between the bellows pump 80 according to the second illustrative embodiment and the diaphragm pump 30 according to the first illustrative embodiment is described below. In the first illustrative embodiment, the diaphragm 31 is provided above the pump housing 32. By contrast, in the second illustrative embodiment, a bellows 81 is disposed above the pump housing 32. The rest of the configuration of the bellow pump 80 is basically the same as the configuration of the diaphragm pump 30 according to the first illustrative embodiment. Specifically, provision of the bellows 81, a shape of a transmission member 85 provided above the bellows 81, and a position of the drive motor 41 installed corresponding to upstroke and downstroke of the bellows 81 are different from the configuration of the first illustrative embodiment.

Use of the bellows pump 80 in the toner supply device 70 achieves the same effects as those achieved by the first illustrative embodiment.

The present illustrative embodiment is applicable not only to the bellows pump 80 but also to other types of reciprocating displacement pumps such as a piston pump.

In addition, the foregoing illustrative embodiments are applicable not only to a powder conveyance device that supplies toner to the developing device but also applicable to a collected toner conveyance device that conveys, together with air, the toner collected to a collection case by the cleaning devices or the belt cleaning device to the sub-hopper connected above the developing device.

Elements and/or features of different illustrative embodiments may be combined with each other and/or substituted for each other within the scope of this disclosure and appended claims.

Illustrative embodiments being thus described, it will be apparent that the same may be varied in many ways. Such exemplary variations are not to be regarded as a departure from the scope of the present invention, and all such modifications as would be obvious to one skilled in the art are intended to be included within the scope of the following claims.

The number of constituent elements and their locations, shapes, and so forth are not limited to any of the structure for performing the methodology illustrated in the drawings.

What is claimed is:

1. A powder conveyance device, comprising:
a reciprocating displacement pump, through which powder, together with air, passes to be conveyed from an origin to a destination using negative pressure and positive pressure alternately generated in the reciprocating displacement pump by changing an internal volume of the reciprocating displacement pump; and
a drive part connected to the reciprocating displacement pump to drive the reciprocating displacement pump,
wherein a period of time to increase the internal volume of the reciprocating displacement pump to generate the negative pressure therein is set longer than a period of time to reduce the internal volume of the reciprocating displacement pump to generate the positive pressure therein.

2. The powder conveyance device according to claim 1, wherein the reciprocating displacement pump is disposed adjacent to the destination.

3. The powder conveyance device according to claim 1, wherein the powder is developer including toner or a mixture of toner and carrier used for an image forming apparatus employing an electrophotographic method.

4. An image forming apparatus, comprising:
a developing device to develop an image with developer including toner or a mixture of toner and carrier;
a container disposed separately from the developing device to store the developer; and
a powder conveyance device comprising:
a reciprocating displacement pump, through which the developer, together with air, passes to be conveyed from the container to a destination using negative pressure and positive pressure alternately generated in the reciprocating displacement pump by changing an internal volume of the reciprocating displacement pump; and
a drive part connected to the reciprocating displacement pump to drive the reciprocating displacement pump,
wherein a period of time to increase the internal volume of the reciprocating displacement pump to generate the negative pressure therein is set longer than a period of time to reduce the internal volume of the reciprocating displacement pump to generate the positive pressure therein.
